(19) United States
(12) Patent Application Publication
(10) Pub. No.: US 2026/0336972 A1
(43) Pub. Date: Oct. 29, 2026

(54) METHOD FOR TRANSMITTING A USER-SPECIFIC MESSAGE FROM A USER DEVICE TO AN ELEVATOR INSTALLATION

(71) Applicant: Inventio AG, Hergiswil (CH)

(72) Inventor: Jacqueline Walther, Ebikon (CH)

(21) Appl. No.: 19/113,441

(22) PCT Filed: Sep. 6, 2023
(86) PCT No.: PCT/EP2023/074362

§ 371 Date: Mar. 20, 2025

(30) Foreign Application Priority Data
Sep. 28, 2022 (EP) 22198227.5

(51) Int. Cl. B66B 3/00

(52) U.S. Cl. CPC B66B 3/008

(57) ABSTRACT

A method for transmitting a user-specific message from a user device to an elevator installation includes steps of: receiving input data, which data a user has input into the user device, in a data processing device of the user device; generating, from the input data, a user-specific message that is to be displayed via a display device of the elevator installation; transmitting the message to the elevator installation via a data communication link that connects the user device to the elevator installation for data communication, in order to enable the message to be displayed via the display device.

### FIELD

The present invention relates to a method for transmitting a user-specific message from a user device to an elevator installation. Furthermore, the invention relates to a method for displaying a user-specific message via a display device of an elevator installation, and to a data processing device, a computer program and a computer-readable medium for carrying out one or both of the methods. The invention further relates to an elevator installation and to an elevator system.

### BACKGROUND

An elevator installation, for example for transporting people and/or objects in buildings, is generally operated via car operating panels and/or landing operating panels. Contactless control is additionally possible by means of a (mobile) user device such as a smartphone or tablet. A corresponding app may be installed on the user device for this purpose. The functionality of such an app is typically limited to the selection of a desired floor and the transmission of a corresponding request to the elevator installation via a wireless data communication link.

There may be a need for a method that enables a user to display user-specific messages via a display device of the elevator installation. Furthermore, there may be a need for a corresponding data processing device, a corresponding computer program, a corresponding computer-readable medium, a corresponding elevator installation and a corresponding elevator system.

### SUMMARY

These needs can be met by the subject matter of the advantageous embodiments defined in the following description and in the accompanying drawings.

A first aspect of the invention relates to a method for transmitting a user-specific message from a user device to an elevator installation, wherein the elevator installation comprises a display device and is connected to the user device via a data communication link for data communication. The method comprises: receiving input data, which a user has input into the user device, in a data processing device of the user device; generating, from the input data, a user-specific message which is to be displayed via the display device; transmitting the message to the elevator installation via the data communication link, in order to enable the message to be displayed via the display device.

The method may be computer-implemented and carried out automatically by a processor, for example of the data processing device of the user device.

The user device may be a device which can be operated by a user and which comprises a computer, such as a server, a PC, a laptop, a tablet, a smartphone, a smartwatch or a remote control of the elevator installation.

The data communication link may be a wired and/or wireless data communication link. For example, the data communication link may be an Ethernet, WLAN, mobile radio, Bluetooth or Internet connection or a combination of at least two of these examples.

It is possible that, based on the input data, one of several possible message contents, in particular with reference to the elevator installation, is selected and the message is generated with the selected message content. However, the message may also be generated with an individual message content that comprises at least part of the input data (for example a text formulated by the user). In other words, the message may also have any desired message content defined by the user. The message content may then be displayed via the display device.

The method allows the display device of the elevator installation to be controlled remotely via the user device, such that particular information selected by the user can be displayed to other users. This improves the exchange of information between the users. For example, such information can assist the users in better planning elevator journeys or better estimating how long an elevator journey to a desired floor will take, which in turn improves user convenience.

A second aspect of the invention relates to a method for displaying a user-specific message via a display device of an elevator installation. The method comprises: receiving a user-specific message, which is to be displayed via the display device, in a data processing device of the elevator installation; displaying the message via the display device by controlling the display device, wherein the message was generated and/or is displayed using a user device belonging to a user, and wherein the user device is connected to the elevator installation via a data communication link for data communication.

In other words, the message is generated or displayed via the display device only as a result of an interaction of the user with the user device and/or an interaction of the user device with the elevator installation. Such an interaction may for example consist in data to be displayed being input into the user device, and/or data to be displayed being received in the elevator installation via the data communication link. Such an interaction may however also consist in the user being uniquely identified, by way of their user device, to the elevator installation, and/or the user device (and thus the user) being detected at (for example inside) or in the vicinity of an elevator car of the elevator car. In this case, certain data, such as the message itself, a unique user ID, a unique elevator identifier or a combination of at least two of these examples, may be transmitted via the data communication link.

The method may be computer-implemented and carried out automatically by a processor, for example of the data processing device of the elevator installation.

A third aspect of the invention relates to a data processing device having a processor that is configured to carry out one or both of the methods described above and below. The data processing device may comprise hardware and/or software modules. In addition to the processor, the data processing device may comprise a memory and a data communication interface for wireless and/or wired data communication with peripheral devices. The data processing device may for example be a component of the user device and/or a component of a control device of the elevator installation.

It should be noted that features of the methods described above and below may also be features of the data processing device (and vice versa).

A fourth aspect of the invention relates to an elevator installation. The elevator installation comprises: an elevator shaft; an elevator car which is movable in the elevator shaft between different floors of a building; a display device; the data processing device described above and below, wherein the processor of the data processing device is configured to carry out the method for displaying the message, as described above and below.

The display device may for example comprise a car display arranged inside the elevator car, and/or a landing display arranged outside the elevator shaft at one of the floors, for displaying the message. For example, the car display may be part of a car operating panel and/or the landing display may be part of a landing operating panel.

It is possible for the message to be displayed in the same way or differently on different displays of the display device. The different displays may for example differ from one another inter alia in terms of their size and/or position.

A fifth aspect of the invention relates to an elevator system. The elevator system comprises the elevator installation described above and below and one or more user devices, wherein each user device comprises the data processing device described above and below. The processor of the data processing device is configured to carry out the method for transmitting the message, as described above and below.

Further aspects of the invention relate to a computer program and a computer-readable medium on which the computer program is stored.

The computer program comprises commands that cause a processor to carry out one or both of the methods described above and below when the computer program is executed by the processor. The computer program may for example be special control software that runs on a control device of the elevator installation, and/or a special app that runs on the user device.

The computer-readable medium can be a volatile or non-volatile data memory. For example, the computer-readable medium may be a hard disk, a USB storage device (universal serial bus), a RAM (random access memory), a ROM (read-only memory), an EPROM (erasable programmable read-only memory), an EEPROM (electrically erasable programmable read-only memory), a flash memory or a combination of at least two of these examples. The computer-readable medium may also be a data communication network that allows program code to be downloaded (for example via the Internet), or a cloud.

It should be noted that features of the methods described above and below may also be features of the computer program and/or of the computer-readable medium (and vice versa).

Embodiments of the invention may be considered to be based on the concepts and findings described below. These embodiments are not to be understood as limiting the scope of the invention.

In one embodiment, the input data may comprise a desired display time at which the message is to be displayed, such as a time, date, day of the week, calendar week, month, or year.

Additionally or alternatively, the input data may comprise a desired display duration for which the message is to be displayed, for example in seconds, minutes, hours, days, weeks, months or years.

Additionally or alternatively, the input data may comprise a desired repeat pattern in accordance with which the displaying of the message is to be repeated, for example hourly, daily, weekly, monthly or at a user-defined frequency.

Additionally or alternatively, the input data may comprise a text formulated by the user (and to be displayed via the display device). However, the input data may also comprise audio and/or image data for playback via the display device, for example a voice and/or video message recorded by the user.

These input data may for example be input via a special app running on the user device.

It is also conceivable for the message to be transmitted and/or displayed in accordance with the user's current location. The message may be transmitted and/or displayed only if the current location matches a desired location. The current and/or desired location may for example be part of the input data and/or transmitted to the elevator installation via the data communication link. For example, the current location may be determined in a digital map by means of a receiver for a global navigation satellite system (for example GPS, GLONASS, Galileo or Beidou) or some other location sensor that may be part of or coupled to the user device.

In one embodiment, the method for displaying the message may further comprise transmitting the message by carrying out the steps of the method for transmitting the message, as described above and below. In this case, features of the method for transmitting the message are to be understood as features of the method for displaying the message.

In one embodiment, the method for displaying the message may further comprise the following steps: displaying an indication of an alternative floor, to which the user could walk from a current floor, via the display device by controlling the display device and/or by transmitting the indication to the user device via the data communication link, in order to enable the indication to be displayed via the user device, wherein the indication prompts the user to confirm the alternative floor. Once the confirmation is received, the receipt of a signal transmitted by the user device is awaited for a certain waiting time, wherein the received signal indicates that the user has entered an elevator car, which is located at the alternative floor, of the elevator installation. The message is displayed only if the signal is received within the waiting time.

In other words, using the user device, it can be identified whether a particular user has walked at least part of an elevator route. In this case, a corresponding message can be automatically displayed via the display device. By virtue of the message being displayed, the user in question may for example be visually highlighted compared to other users (who have not walked), for example by being marked with a symbol as being particularly environmentally conscious.

The confirmation may for example be input via an operating panel of the elevator installation and/or via the user device. It is also conceivable that the user inputs the confirmation via an operating panel of the elevator installation and, in response, information relating to the alternative floor is transmitted to the user device (preferably via a wireless data communication link), such that the information, for example a designation of the alternative floor and/or directions, can be retrieved via the user device independently of the elevator installation. This has the advantage that the user can conveniently view the information on the go via their user device.

The signal transmitted by the user device may comprise a unique user ID, such that the user can be uniquely identified using the signal. For example, the user device may be equipped with an active or passive (RFID) transponder for transmitting the signal and/or configured to transmit the signal with a range of no more than 10 meters, preferably no more than 1 meter. The signal may be transmitted automatically, for example in response to the confirmation of the alternative floor, or as a result of an additional user input, that is to say may be triggered by the user by means of the user device.

The elevator installation may be equipped with one or more receiving devices for receiving the signal. Such a receiving device (also referred to as a read device) may for example be arranged on or inside the elevator car or in the vicinity of a door area through which the elevator car is accessible to users of the elevator installation from a floor (see further below).

It is also conversely possible for the user device to comprise a read device and for the receiving device of the elevator installation to be an active or passive (RFID) transponder.

This makes it possible for the user to be contactlessly identified and/or localized by way of their user device.

A variant is also possible in which the user transmits a user-specific message to the elevator installation and the message is stored there, but the message is displayed via the display device only if the signal is received within the waiting time, that is to say if it is identified (in time) that the user has walked part of an elevator route.

In one embodiment, the signal may be received via a receiving device arranged on (for example inside) or in the vicinity of the elevator car. Such a receiving device may be a transmitter and/or receiver for wireless data communication, for example via Bluetooth and/or using an RFID method. The receiving device may be a component of the data processing device of the elevator installation or may be connected to the data processing device of the elevator installation for data communication.

In one embodiment, by virtue of the message being displayed, at least one of the following pieces of information may be displayed:
input data which the user has input into the user device (for example, as mentioned further above, a text formulated by the user);
a user ID for uniquely identifying the user (for example their name, their initials, their pseudonym, their photograph, their avatar, a unique character string or a combination of at least two of these examples);
a symbol that (additionally) distinguishes the user, or more specifically their displayed user ID, from other users, or more specifically from their displayed user IDs;
a floor desired by the user, at which the elevator installation should stop;
an elevator desired by the user, from among a plurality of possible elevators of the elevator installation.

At least one of the pieces of information from among user ID, symbol, desired floor and desired elevator may be part of the input data, that is to say may have been input by the user into the user device.

The symbol may for example be a pictogram, an image, a text or a combination of at least two of these examples. For example, the symbol may identify the user as being particularly environmentally conscious or generally as a user who is particularly worthy of emulation (with regard to their usage behavior). The symbol may be displayed (for example next to a user ID assigned to the user) in particular if the user has walked part of an elevator route and is to be highlighted compared to other users who have not walked (see also further above).

If the user is a building manager, they can, for example, by transmitting a corresponding user-specific message to the elevator installation, display information regarding a current status of the elevator installation (for example “maintenance”, “repair” or “cleaning”), regarding a current operating mode of the elevator installation (for example “energy saving mode active” or “silent mode active”) or regarding certain types of users being transported by the elevator installation (for example “elevator staff” or “wheelchair users”).

It is possible for a priority to additionally be determined for the message, and for the message to be received and/or displayed according to its priority. This allows messages with higher priority to be prioritized over messages with lower priority.

The priority may for example be determined using a user ID associated with the message. In other words, messages from different users may differ from one another inter alia in terms of their priority. For example, the message from a building manager (see further above) may generally have a higher priority than the message from a normal passenger in the elevator installation.

In one embodiment, the message may be received in the data processing device of the elevator installation via the data communication link. This allows the message to be generated independently of and/or outside the elevator installation.

In one embodiment, the desired floor from the message may be displayed differently than if the desired floor were input via an operating panel of the elevator installation and displayed via the display device. This allows a visual distinction to be made between the desired floors displayed, in accordance with whether they were input via a user device or via an operating panel. For example, in cases where multiple users are waiting in front of one or more elevators of the elevator installation in order to travel to the same floor, it can be confusing if the floor is displayed in the same way for each user. For example, a user who has requested a floor via their user device does not know whether the displayed floor was requested by them or by another user, who is also waiting, via the operating panel.

In one embodiment, at least one second user device may be connected to the user device and/or to the elevator installation via the data communication link for data communication. In this case, the method may further comprise transmitting the message to the second user device or the second user devices via the data communication link, in order to enable the message to additionally be displayed via the second user device or the second user devices. This allows the message to be displayed to users regardless of their location. In other words, the message can thus also be displayed to users who are not in the vicinity of the display device, that is to say the users do not necessarily need to be in the vicinity of the display device to be informed of the message.

Embodiments of the invention will be described below with reference to the accompanying drawings. Neither the description nor the drawings are to be understood as limiting the scope of the invention.

### DESCRIPTION OF THE DRAWINGS

FIG. 1 shows an elevator system according to an embodiment of the invention.

FIG. 2 shows a display device of an elevator installation according to an embodiment of the invention.

The drawings are purely schematic and are not to scale. Where the same reference signs are used in different drawings, these reference signs denote identical or equivalent features.

### DETAILED DESCRIPTION

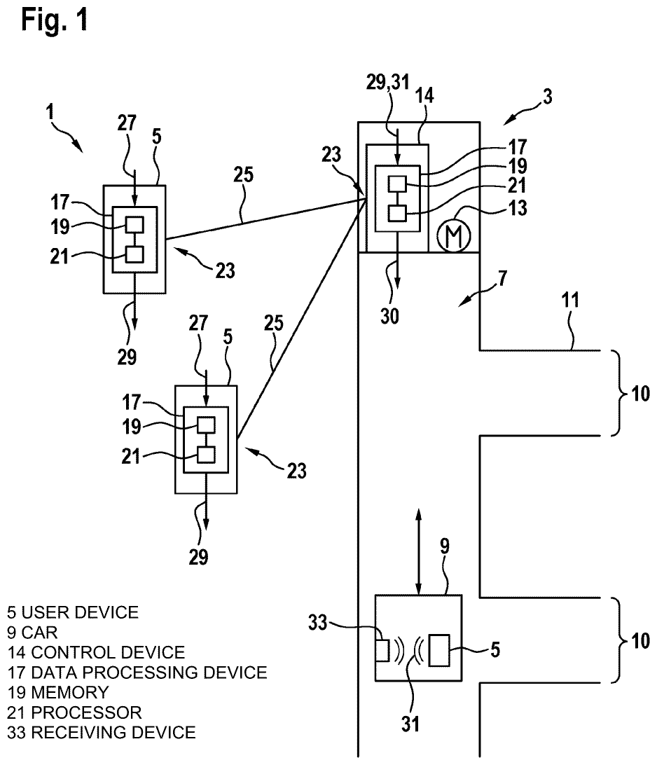

FIG. 1 shows an elevator system 1, which comprises an elevator installation 3 and a user device 5, in this case a smartphone. The user device 5 may however also be a PC, a laptop, a tablet, a smartwatch or a specially designed remote control. The elevator system 1 may also comprise two (as is the case here) or more than two user devices 5.

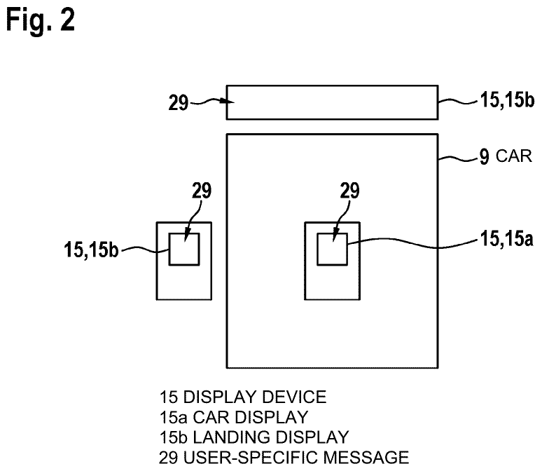

The elevator installation 3 comprises an elevator shaft 7 in which an elevator car 9 (hereinafter referred to as car 9) is movable between a plurality of floors 10 of a building 11 by means of an electric drive 13. In addition, the elevator installation 3 comprises a control device 14 for controlling components of the elevator installation 3, for example the electric drive 13, in accordance with desired floors at which the car 9 is to stop, and a display device 15 (see FIG. 2), on which certain information relevant to users of the elevator installation 3 can be displayed.

As shown in FIG. 2, the display device 15 may comprise a plurality of displays, for example a car display 15a, which may be arranged inside the car 9, and/or a landing display 15b, which may be arranged next to or above a door area through which the car 9 is accessible to the users from a floor 10.

Each of the devices 5, 14 comprises a data processing device 17 having a memory 19, on which a special computer program is stored, having a processor 21, which is configured to execute the computer program, and having a data communication interface 23. The data communication interface 23 of the user device 5 is connected to the data communication interface 23 of the control device 14 via a data communication link 25 for data communication, in this case for wireless data communication, for example via WLAN, mobile radio, Bluetooth and/or the Internet. A wired data communication link 25 is however also possible. The data communication between the devices 5, 14 may take place directly or indirectly, for example via at least one server and/or at least one other user device.

By virtue of the processor 21 of the user device 5 executing the computer program stored in the memory 19 of the user device 5, the following steps of a method for transmitting a user-specific message to the elevator installation 3 can be carried out.

In a first step, input data 27 which a user has input into the user device 5, in this case for example via a touch display of the smartphone in a special elevator app running on the smartphone, are received in the data processing device 17 of the user device 5.

The input data 27 comprise, firstly, pieces of information that are to be displayed via the display device 15, for example a text formulated by the user, a voice message recorded by the user, a video message recorded by the user or a combination of at least two of these examples. Such a piece of information may also be a user ID for uniquely identifying the user (for example their name, their initials, their pseudonym, their photograph, their avatar, a unique character string or a combination of at least two of these examples), a floor desired by the user, or an elevator desired by the user from among a plurality of possible elevators of the elevator installation 3.

In addition, the input data 27 may define, that is to say the user may define by inputting corresponding input data 27, when and/or for how long and/or in accordance with what repeat pattern these pieces of information should be displayed.

In a second step, from the input data 27, a user-specific message 29 which is to be displayed via the display device 15 is generated. The content of the message 29 to be displayed may correspond to the input data 27 or to at least part thereof.

In a third step, the message 29 is finally transmitted to the data processing device 17 of the control device 14 via the data communication link 25, in order to enable the message 29 to be displayed via the display device 15.

In addition, the user device 5 may transmit the message 29 to at least one second user device 5, in order to enable the message 29 to also be displayed via the second user device 5.

By virtue of the processor 21 of the control device 14 executing the computer program stored in the memory 19 of the control device 14, the following steps of a method for displaying a user-specific message 29 via the display device 15 can be carried out.

In a first step, the message 29 is received in the data processing device 17 of the control device 14. For example, the message 29 may be read out of the memory 19 of the control device 14. However, the message 29 may also be received via the data communication link 25, that is to say from the user device 5, as is the case here. In this case, the message 29 may have been transmitted by virtue of the steps of the transmitting method described above being carried out.

In a second step, the control device 14 generates a control command 30 which causes the message 29 to be displayed via the display device 15, for example in accordance with the aforementioned display parameters such as display time, display duration and repeat pattern.

In general, at least one interaction of the user device 5 with the user (see further above) and/or with the control device 14 (see further below) is required to generate and/or display the message 29.

It is possible, for example, that the message 29 is displayed in accordance with whether the user walks at least part of an elevator route between two floors 10 that are connected to one another by a staircase, or covers the entire elevator route in the car 9.

In this case, for example, an indication of an alternative floor to which the user could walk from a current floor may be displayed by virtue of the control device 14 controlling the display device 15 such that the indication is displayed via the display device 15 and/or transmitting the indication to the user device 5 via the data communication link 25, in order to enable the indication to be displayed via the user device 5, in this case for example via the touch display of the smartphone in the elevator app.

The indication may also prompt the user to confirm the displayed alternative floor in a specific way. The confirmation may for example be input by means of a control element on an operating panel of the elevator installation 3 and/or via the user device 5 (for example by touching a corresponding control panel on a touch display of the operating panel or of the user device 5).

In both cases, the confirmation may be received in the data processing device 17 of the control device 14 and processed further there.

The receipt of the confirmation may trigger a timer. If, within a certain waiting time following the receipt of the confirmation, a signal 31 transmitted by the user device 5 is received in the control device 14, for example via a receiving device 33 in the form of an RFID read device that is situated in a car 9 located at the alternative floor, then the message 29 is displayed. Otherwise, that is to say if the signal 31 is not received or is only received after the waiting time has elapsed, then the message 29 is not displayed.

By virtue of the message 29 being displayed, the user in question who has walked can be distinguished, for example by means of a specific symbol next to their user ID, which is also displayed, from other users who may not have walked (more specifically from the displayed user IDs of those users) and as being a user who is particularly environmentally friendly and/or worthy of emulation. In addition, by virtue of the message 29 being displayed, information relating to a length of the elevator route covered on foot, and/or an associated (estimated) energy saving, may be displayed.

The waiting time may be constant, that is to say set to a specific value such as 5, 10 or 15 minutes. It is however also possible for the waiting time to be varied, for example depending on the length of the elevator route to be covered on foot and/or depending on the current capacity utilization of the elevator installation 3. The longer the elevator route to be covered on foot and/or the higher the capacity utilization of the elevator installation 3 (that is to say the longer the user, having arrived at the alternative floor, may have to wait for a car 9 in order to cover the rest of the elevator route in the car 9), the longer the waiting time can be selected to be.

If the message 29 comprises a desired floor, as mentioned further above, then it is possible for the control device 14 to control the display device 15, in order to display the desired floor from the message 29, differently than if the same floor were input in the conventional way via an operating panel of the elevator installation 3 and displayed as the desired floor via the display device 15.

For example, if a first user waiting in front of a first elevator of the elevator installation 3 requests a floor via their user device 5, whilst a second user waiting in front of a second elevator of the elevator installation 3 requests the same floor via the operating panel, then a display device 15 of the first elevator may additionally display a first symbol, which is assigned to the user device 5, next to the designation of the desired floor, and a display device 15 of the second elevator may additionally display a second symbol, which differs from the first symbol and is assigned to the operating panel, next to the designation of the desired floor. This allows the users to be clearly associated with the desired floors displayed, even if these correspond in terms of their designation.

It is possible for the control device 14 to additionally transmit the message 29 to at least one second user device 5 in order to enable the message 29 to also be displayed via the second user device 5.

Finally, it should be noted that terms such as “having,” “comprising,” “including,” “with,” etc. do not exclude other elements or steps, and indefinite articles such as “a” or “an” do not exclude a plurality. Furthermore, it should be noted that features or steps described with reference to any one of the above embodiments may also be used in combination with features or steps that have been described with reference to other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for transmitting a user-specific message from a user device to an elevator installation, the elevator installation including a display device, the elevator installation being connected to the user device via a data communication link for data communication, wherein the method comprises steps of:
receiving input data that a user has input into the user device in a data processing device of the user device;
the user device generating, from the input data, a user-specific message configured to be displayed via the display device; and
transmitting the message to the elevator installation via the data communication link and displaying the message via the display device.

17. The method according to claim 16 wherein the input data includes at least one of:
a desired display time at which the message is to be displayed via the display device;
a desired display duration for which the message is to be displayed via the display device;
a desired repeat pattern in accordance with which the displaying of the message via the display device is to be repeated; and
a text formulated by the user to be displayed via the display device.

18. A data processing device including a processor adapted to perform the method according to claim 16.

19. A computer program product comprising computer program commands that, when stored on a non-transitory computer-readable medium and executed by a processor of the data processing device, cause the user device to carry out the method according to claim 16.

20. A non-transitory computer-readable medium on which the computer program product according to claim 19 is stored.

21. A method for displaying a user-specific message via a display device of an elevator installation, wherein the method comprises steps of:
receiving a user-specific message, the message being adapted to be displayed via the display device, in a data processing device of the elevator installation;
displaying the message via the display device by controlling the display device; and
wherein the message was generated and/or is displayed using a user device operated by a user, the user device being connected to the elevator installation via a data communication link for data communication of the message.

22. The method according to claim 21 wherein the message is received via the data communication link.

23. The method according to claim 21 including steps of:
receiving in a data processing device of the user device input data that the user has input into the user device;
the user device generating, from the input data, the user-specific message; and
transmitting the message to the elevator installation via the data communication link and displaying the message via the display device.

24. The method according to claim 21 including steps of:
displaying an indication of an alternative floor of the elevator installation to which the user could walk from a current floor by controlling the display device to display the indication and/or by transmitting the indication to the user device via the data communication link and displaying the indication via the user device, and wherein the indication prompts the user to confirm the alternative floor;
in response to receiving a confirmation from the user via the user device in the data processing device of the elevator installation, waiting for a predetermined waiting time for receipt of a signal transmitted by the user device, the signal indicating that the user has entered an elevator car located at the alternative floor of the elevator installation; and
displaying the message when the signal is received within the waiting time.

25. The method according to claim 24 including receiving the signal via a receiving device arranged on or in a vicinity of the elevator car.

26. The method according to claim 21 including in response to the message being displayed, displaying via the display device information including at least one of:
input data that the user has input into the user device;
a user ID uniquely identifying the user;
a symbol that distinguishes the user from other users;
a floor selected by the user at which an elevator car of the elevator installation should stop; and
an elevator car selected by the user from a plurality of elevator cars of the elevator installation.

27. The method according to claim 26 wherein the selected floor displayed in response to the message being displayed is displayed differently than when the selected floor is input via an operating panel of the elevator installation and is displayed via the display device.

28. The method according to claim 21 wherein the user device is a first user device, a second user device is connected to the first user device and/or to the elevator installation via the data communication link for data communication, and including transmitting the message to the second user device via the data communication link and displaying the message via the second user device.

29. A data processing device including a processor adapted to perform the method according to claim 21.

30. An elevator installation comprising:
an elevator shaft;
an elevator car movable in the elevator shaft between floors of a building including the elevator shaft;
a display device; and
a data processing device according to claim 29 in data communication with the display device and the user device.

31. An elevator system comprising:
the elevator installation according to claim 30; and
a user device including a data processing device having a processor adapted to carry out steps of:
receiving input data that a user has input into the user device in the data processing device of the user device;
the user device generating, from the input data, the user-specific message configured to be displayed via the display device; and
transmitting the message to the elevator installation via the data communication link.

32. A computer program product comprising computer program commands that, when stored on a non-transitory computer-readable medium and executed by a processor of an elevator system, cause the elevator system to carry out the method according to claim 21.

33. A non-transitory computer-readable medium on which the computer program product according to claim 32 is stored.
